(19) United States
(12) Patent Application Publication
(10) Pub. No.: US 2018/0046020 A1
(43) Pub. Date: Feb. 15, 2018

(54) LIQUID CRYSTAL DISPLAY APPARATUS AND ITS LIQUID CRYSTAL PANEL

(71) Applicant: Wuhan China Star Optoelectronics Technology Co., Ltd., Wuhan, Hubei (CN)

(72) Inventors: Xingling GUO, Shenzhen, Guangdong (CN); Chun-hung HUANG, Shenzhen, Guangdong (CN); Man LI, Shenzhen, Guangdong (CN)

(73) Assignee: Wuhan China Star Optoelectronics Technology Co., Ltd., Wuhan, Hubei (CN)

(21) Appl. No.: 15/039,588

(22) PCT Filed: Apr. 1, 2016
(86) PCT No.: PCT/CN2016/078266

§ 371 Date: May 26, 2016

(30) Foreign Application Priority Data
Jan. 28, 2016 (CN) 201610058153.0

(51) Int. Cl. G02F 1/1335; G02F 1/1345; G02F 1/1362

(52) U.S. Cl. CPC G02F 1/133528; G02F 1/133514; G02F 1/136286; G02F 1/13458; G02F 2202/28

(57) ABSTRACT

The present application discloses a liquid crystal panel, including: a color filter substrate; an array substrate pair disposed to the color filter substrate; a liquid crystal layer interposed between the color filter substrate and the array substrate; a first polarizer attached to the surface of the array substrate facing away from the color filter substrate; and a second polarizer attached to the surface of the color filter substrate facing away from the array substrate and connected to the ground line on the array substrate. The present application also discloses a liquid crystal display apparatus with the liquid crystal panel. By using a conductive adhesive to connect the conductive polarizer and the ground line on the array substrate of the present application can make the performance of the liquid crystal panel more stable, and the display effect of the liquid crystal display panel is more excellent, and the manufacturing process of the liquid crystal panel is more optimized, and the costs also dropped significantly.

### FIELD OF THE INVENTION

The present application relates to a liquid crystal display technology field, and more particularly to a liquid crystal display apparatus and its liquid crystal panel.

### BACKGROUND OF THE INVENTION

With the vigorous development of the liquid crystal display industry, the different sizes of LCD monitors have entered the market to meet the different needs of consumers. For different sizes of liquid crystal display design and production of differences, liquid crystal display technology manufacturers to establish a different generation panel plant. At present, the LCD panel plant is divided into G4 to G10 generation line by the production of LCD panels sizes; wherein, on behalf of the G4 line, the glass substrate with a size of 68 cm×88 cm is used to produce the LCD panels; for the G4 line, the glass substrate with a size of 288 cm×313 cm is used to produce the LCD panels. The using of different size glass substrate size means the equipment size, capacity, process, accuracy and the working process of different LCD panel plant used are not the same. For cost and technical considerations, the LCD panel plant usually adopts a certain size to purchase and set up the substrate supporting the process capability of the production line.

Usually liquid crystal panel production processes is to produce a TFT array on the glass substrate, and then producing a color filter substrate (i.e., the CF substrate) on a glass substrate of the same size, then align the TFT array substrate and the CF substrate together, filling the liquid crystal between the TFT array substrate and the CF substrate, this step is called “a cassette.” After the cassette, the glass is usually thinned. After thinning, in order to stabilize the electrical field of the display, a layer of transparent conductive material ITO (indium tin oxide) will be deposited on the CF substrate after thinning, and the ITO layer is further connected to the ground of the TFT array substrate, thereby stabilize the electrical field of the display.

However, in the present technical, for some reason, the conductive material of ITO cannot be plated on the CF substrate. The solution to this problem is to choose a conductive polarizer (POL) to replace ITO. For example, a conductive POL is attached on the surface of the CF substrate and then dropping silver to connect the ground line on the TFT array substrate. But this method also has many problems, such as the higher manufacturing process cost and more complex process to drop silver, the poor adhesive of the silver is easy to cause the disconnect the circuit and affect the manufacturing yield and the like.

### SUMMARY OF THE INVENTION

In order to solve the present technical problem mentioned above, the propose of the present application is to provide a liquid crystal panel, including: a color filter substrate; an array substrate pair disposed to the color filter substrate; a liquid crystal layer interposed between the color filter substrate and the array substrate; a first polarizer attached to the surface of the array substrate facing away from the color filter substrate; and a second polarizer attached to the surface of the color filter substrate facing away from the array substrate and connected to the ground line on the array substrate.

The another propose of the present application is to provide a liquid crystal display apparatus with a liquid crystal panel and a backlight module formed oppositely wherein the liquid crystal panel including: a color filter substrate formed opposite to the backlight module; an array substrate disposed between the color filter substrate and the backlight module and pair disposed to the color filter substrate; a liquid crystal layer interposed between the color filter substrate and the array substrate; a first polarizer attached to the surface of the array substrate toward the backlight module; and a second polarizer attached to the surface of the color filter substrate facing away from the array substrate and connected to the ground line on the array substrate.

Further, one end of the array substrate is extending beyond the color filter substrate to form an extended end, and the ground line is provided on the surface of the extended end extends toward to the color filter substrate.

Further, the second polarizer is extended over the color filter substrate to form a connecting terminal, and the connecting terminal is connected to the ground line.

Further, the second polarizer is connected to the ground line on the array substrate by the conductive adhesive.

Further, the connecting terminal is connected to the ground line by the conductive adhesive.

The advantage of the present application is by using a conductive adhesive to connect the conductive polarizer and the ground line on the array substrate makes the performance of the liquid crystal panel more stable, and the display effect of the liquid crystal display panel is more excellent, and the manufacturing process of the liquid crystal panel is more optimized, and the costs also dropped significantly.

### BRIEF DESCRIPTION OF THE DRAWINGS

In order to more clearly illustrate the embodiments of the present application or prior art, the following figures will be described in the embodiments are briefly introduced. It is obvious that the drawings are merely some embodiments of the present application, those of ordinary skill in this field can obtain other figures according to these figures without paying the premise.

FIG. 1 is a schematic diagram of the second polarizer according to one embodiment of the present application;

FIG. 2 is a schematic structure of a liquid crystal panel according to one embodiment of the present application;

FIG. 3 is a schematic view of the structure of the liquid crystal display according to one embodiment of the present application.

### DETAILED DESCRIPTION OF PREFERRED EMBODIMENTS

Embodiments of the present application are described in detail with the technical matters, structural features, achieved objects, and effects with reference to the accompanying drawings as follows. It is clear that the described embodiments are part of embodiments of the present application, but not all embodiments. Based on the embodiments of the present application, all other embodiments to those of ordinary skill in the premise of no creative efforts obtained should be considered within the scope of protection of the present application.

Specifically, the terminologies in the embodiments of the present application are merely for describing the purpose of the certain embodiment, but not to limit the invention. Examples and the appended claims be implemented in the present application requires the use of the singular form of the book “an”, “the” and “the” are intended to include most forms unless the context clearly dictates otherwise. It should also be understood that the terminology used herein that “and/or” means and includes any or all possible combinations of one or more of the associated listed items.

In the drawings, in order to clarify the device, an exaggerated thickness of layers and regions are shown. The same reference numerals in the drawings refer to like elements throughout.

It will be understood that, although the term may be used herein “first”, “second”, etc. to describe various elements, these elements should not be limited by these terms. These terms are only used to distinguish one element from another separate.

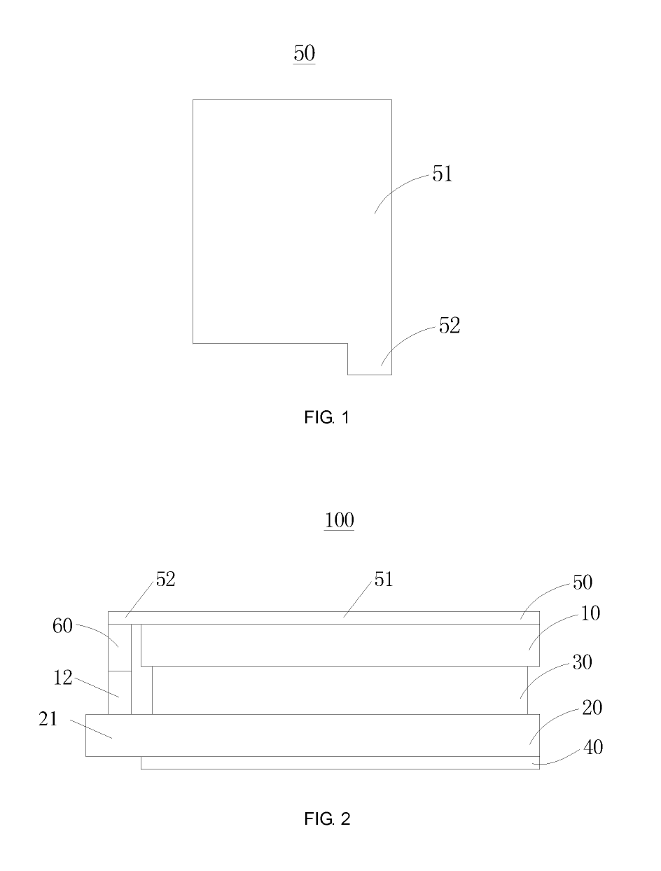

FIG. 1 is a schematic diagram of a plane of the second polarizer embodiment of the present application.

Referring to FIG. 1, the second polarizer 50 according to one embodiment of the present application includes: a sheet body 51 and the connecting terminal 52 extended from one side of the sheet body 51. As shown in FIG. 1, the connecting terminal 52 is not entire extended from the side the sheet body 51, but extended from portion of the side of the sheet body 51. In other words, it is extended from the junction of the adjacent sides of the sheet body 51 to form a connecting terminal 52; however, the present application is not limited thereto.

In this embodiment, the second polarizer 50 is a conductive polarizing.

FIG. 2 is a schematic structure of a liquid crystal panel according to one embodiment of the present application.

Referring to FIG. 1 and FIG. 2, a liquid crystal panel 100 according to one embodiment of the present application includes: a color filter substrate 10, an array substrate 20, a liquid crystal layer 30, a first polarizer 40, and a second polarizer 50.

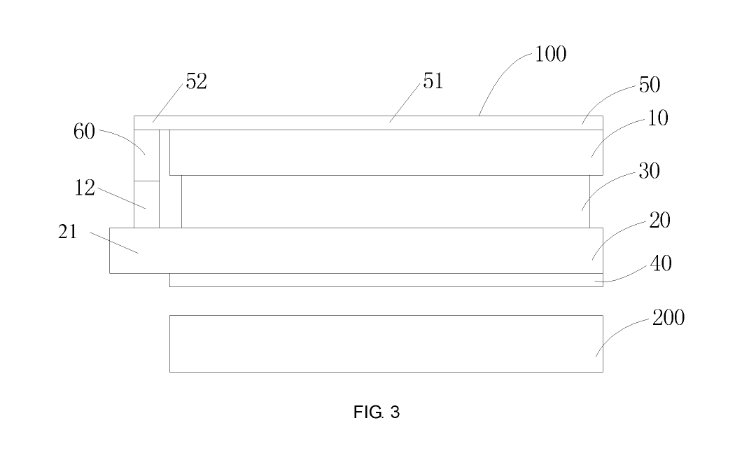

The color filter substrate 10 and the array substrate 20 are align and paired. Here, when the liquid crystal panel 100 and a backlight module 200 is opposing set (as illustrated in FIG. 3), it can also be described as the color filter substrate 10 is disposed opposite to the backlight module 200, the array substrate 20 is provided between the color filter substrate 10 and the backlight module 200 and paired with the color filter substrate 10. In the present embodiment, the color filter substrate 10 includes: the three color resist, such as RGB color resist, a black matrix, and other necessary components, and the array substrate 20 includes: a thin film transistor, pixel electrodes and other necessary components. Since the present application is not aimed at the two basic concrete structures, not repeat them here. A liquid crystal layer 30 is sandwiched between the color filter substrate 10 and the array substrate 20. The liquid crystal layer 30 having a plurality of liquid crystal molecules, wherein the liquid crystal molecules deflect according to the applied voltage.

The first polarizer 40 is attached on the surface of the array substrate 20 facing away from the color filter substrate 10. Here, when the liquid crystal panel 100 and a backlight module 200 are opposing set (as shown in FIG. 3), it may also be described as the first polarizing plate 40 is attached on the surface of the array substrate 20 toward to the backlight module 200.

The second polarizer 50 is attached on the surface of the color filter substrate 10 facing away the array substrate 20 and is connected to the ground line 12 of the array substrate 20. Specifically, one end of the array substrate 20 is extending beyond the color filter substrate 10 to form an extended end 21, the ground line 12 is provided on the surface of the extended end 21 extends toward to the color filter substrate 10. The sheet body 51 of the second polarizer 50 is fully attached to the surface of the color filter substrate 10 facing away from the array substrate 20, so that the connecting terminal 52 of the second polarizer 50 is outside the color filter substrate 10, and the connecting terminal 52 of the second polarizer 50 is facing to the ground line 12 on the array substrate 20.

Further, after the second polarizer 50 is attached to the surface of the color filter substrate 10 facing away from the array substrate 20, the connecting terminal 52 of the second polarizer 50 and the ground line 12 on the color filter substrate 10 is connected by the conductive adhesive 60. Here, the conductive adhesive 60 can be pre-formed on the ground line 12 of the color filter substrate 10; when the second polarizer 50 is attached on the surface of the color filter substrate 10 facing away from the array substrate 20, the connecting terminal 52 of the second polarizer 50 and the ground line 12 on the color filter substrate 10 is pair-bounded connected by the conductive adhesive 60.

FIG. 3 is a schematic view of the structure of the liquid crystal display according to one embodiment of the present application.

Referring to FIG. 3, a liquid crystal display apparatus according to an embodiment of the present application includes the liquid crystal panel 100 shown in FIG. 2 and a backlight module 200 disposed opposite to the liquid crystal panel 100; wherein the backlight module 200 provides uniform area light source to the liquid crystal panel 100 and to display image by the liquid crystal panel 100.

In summary, according to the embodiments of the present application, by using a conductive adhesive to connect the conductive polarizer and the ground line on the array substrate can make the performance of the liquid crystal panel more stable, and the display effect of the liquid crystal display panel is more excellent, and the manufacturing process of the liquid crystal panel is more optimized, and the costs also dropped significantly.

Above are embodiments of the present application, which does not limit the scope of the present application. Any modifications, equivalent replacements or improvements within the spirit and principles of the embodiment described above should be covered by the protected scope of the invention.

What is claimed is:

1. A liquid crystal panel, comprising:
a color filter substrate;
an array substrate pair disposed to the color filter substrate;
a liquid crystal layer interposed between the color filter substrate and the array substrate;
a first polarizer attached to the surface of the array substrate facing away from the color filter substrate; and
a second polarizer attached to the surface of the color filter substrate facing away from the array substrate and connected to the ground line on the array substrate.

2. The liquid crystal panel according to claim 1, wherein one end of the array substrate is extending beyond the color filter substrate to form an extended end, and the ground line is provided on the surface of the extended end extends toward to the color filter substrate.

3. The liquid crystal panel according to claim 1, wherein the second polarizer is extended over the color filter substrate to form a connecting terminal, and the connecting terminal is connected to the ground line.

4. The liquid crystal panel according to claim 2, wherein the second polarizer is extended over the color filter substrate to form a connecting terminal, and the connecting terminal is connected to the ground line.

5. The liquid crystal panel according to claim 1, wherein the second polarizer is connected to the ground line on the array substrate by the conductive adhesive.

6. The liquid crystal panel according to claim 3, wherein the connecting terminal is connected to the ground line by the conductive adhesive.

7. The liquid crystal panel according to claim 4, wherein the connecting terminal is connected to the ground line by the conductive adhesive.

8. A liquid crystal display apparatus with a liquid crystal panel and a backlight module formed oppositely wherein the liquid crystal panel comprising:
a color filter substrate formed opposite to the backlight module;
an array substrate disposed between the color filter substrate and the backlight module and pair disposed to the color filter substrate;
a liquid crystal layer interposed between the color filter substrate and the array substrate;
a first polarizer attached to the surface of the array substrate toward the backlight module; and
a second polarizer attached to the surface of the color filter substrate facing away from the array substrate and connected to the ground line on the array substrate.

9. The liquid crystal display apparatus according to claim 8, wherein one end of the array substrate is extending beyond the color filter substrate to form an extended end, and the ground line is provided on the surface of the extended end extends toward to the color filter substrate.

10. The liquid crystal display apparatus according to claim 8, wherein the second polarizer is extended over the color filter substrate to form a connecting terminal, and the connecting terminal is connected to the ground line.

11. The liquid crystal display apparatus according to claim 9, wherein the second polarizer is extended over the color filter substrate to form a connecting terminal, and the connecting terminal is connected to the ground line.

12. The liquid crystal display apparatus according to claim 8, wherein the second polarizer is connected to the ground line on the array substrate by the conductive adhesive.

13. The liquid crystal display apparatus according to claim 10, wherein the connecting terminal is connected to the ground line by the conductive adhesive.

14. The liquid crystal display apparatus according to claim 11, wherein the connecting terminal is connected to the ground line by the conductive adhesive.
